(19) United States
(12) Patent Application Publication
(10) Pub. No.: US 2012/0102759 A1
(43) Pub. Date: May 3, 2012

(54) KNIFE CASE

(75) Inventor: JUI-CHENG HUANG, Changhua City (TW)

(73) Assignee: K. H. ZINGERS CO., LTD., Changhua City (TW)

(21) Appl. No.: 12/938,607

(22) Filed: Nov. 3, 2010

(51) Int. Cl. B26B 3/00

(52) U.S. Cl. 30/162

(57) ABSTRACT

A knife case is integrally molded to have a shape matching the blade of a knife, and includes a front end, a rear end, an upper edge, a lower edge, and two lateral sides. A rearward opened blade receiving space is defined on the knife case to extend from the rear end toward the front end, a thumb push is provided on the upper edge to project from the rear end, and a through hole is provided on the thumb push for a fastening strap to extend therethrough. With the knife case having the above structure, the knife received therein can be safely displayed for sale without the need of extra packaging material and a user can conveniently and safely remove the knife from the knife case for use.

### FIELD OF THE INVENTION

The present invention relates to a knife case, and more particularly to an improved knife case for safely receiving the blade of a knife therein and allowing a user to conveniently and safely remove the knife from the knife case for use.

### BACKGROUND OF THE INVENTION

Conventionally, a fruit knife, a cook's knife or other type of cutter is usually provided with a knife case for receiving the blade of the knife therein, lest the user should carelessly touch the edge of the blade and get injured. The knife case also protects the knife against undesirable collision with other objects to damage or blunt the blade or the edge thereof. However, the conventional knife case is integrally formed of a plastic material to provide at one end with a narrow slot for the knife blade to insert into the knife case. The knife inserted in the knife case tends to move reversely and separate from the knife case at any time. Therefore, the narrow slot on the knife case is usually designed to slightly compress against the blade, so as to prevent the blade from arbitrarily moving out of the knife case. The conventional knife case also lacks a force application point for a user to release the knife case from the knife, and the blade compressed in the narrow slot of the knife case can not be easily and conveniently extracted from the knife case for use. Moreover, when the knife received in the knife case is displayed for sale, the knife and the knife case are usually packaged in a paper box or other expensive packaging material to prevent a consumer from arbitrarily extracting the knife from the knife case to cause safety problem during display for sale. The extra packaging box or material would inevitably increase the cost of the knife to reduce its competing ability in the market. The discarded packaging box or material of the knife and knife case would also cause the problem of recycling.

It is therefore tried by the inventor to develop an improved knife case that not only allows a user to apply a force to conveniently release the knife case from the knife, but also enables safe display of the knife for sale without the need of extra packaging materials, so as to overcome the problems in the conventional knife case.

### SUMMARY OF THE INVENTION

A primary object of the present invention is to provide a knife case that includes a blade receiving space, a thumb push and a through hole for fastening strap, so that a knife can be safely received in the knife case for storage or for display without the need of extra packaging material to thereby save the packaging cost, and a user can conveniently and safely remove the knife from the knife case for use.

To achieve the above and other objects, the knife case according to the present invention includes an integrally molded case having a shape matching the blade of a knife and including a front end, a rear end, an upper edge, a lower edge, and two lateral sides; a rearward opened blade receiving space being defined on the knife case to extend from the rear end toward the front end; a thumb push being provided on the upper edge to rearward project from the rear end; and a through hole being provided on the thumb push for a fastening strap to extend therethrough.

In the present invention, the blade receiving space is a narrow slot extended from the rear end toward the front end of the knife case for the blade of the knife to insert thereinto.

In the present invention, the thumb push is a wedge-shaped block with a rear end of which serving as a thumb-push surface. A user can safely release the knife case from the knife by gripping at a handle of the knife with one hand and pushing against the thumb-push surface with the thumb of the same hand.

In the present invention, the through hole is a round hole transversely extended through the wedge-shaped block.

In the present invention, the knife case is provided on one of the two lateral sides with a window, via which a trademark provided on one side face of the blade of the knife is shown.

In the present invention, the knife case is molded with a transparent plastic material.

The knife case of the present invention with the above-described structure can be used to safely receive the blade of a knife, such as a fruit knife, a cook's knife or other type of cutter, in the blade receiving space, so as to protect an edge of the knife blade against damage. Moreover, with the thumb push, a user can safely and conveniently release the knife case from the knife simply by gripping at the handle of the knife with one single hand, and then pushing against the thumb-push surface of the thumb push with the thumb of the same hand. Particularly, with the through hole provided on the thumb push, a conventional fastening strap can be extended through the through hole for securely tying to the knife handle, so as to prevent a consumer from arbitrarily extracting the knife from the knife case when the knife is displayed for sale. Therefore, the knife along with the knife case thereof can be safely displayed for sale without the need of extra packing materials to thereby reduce the packaging cost of the knife.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view showing a knife case according to a preferred embodiment of the present invention and a knife to be received in the knife case;

FIG. 2 is an assembled view of FIG. 1; and

FIG. 3 is a cross-sectional view taken along line A-A′ of FIG. 2.

### DETAILED DESCRIPTION OF THE PREFERRED EMBODIMENTS

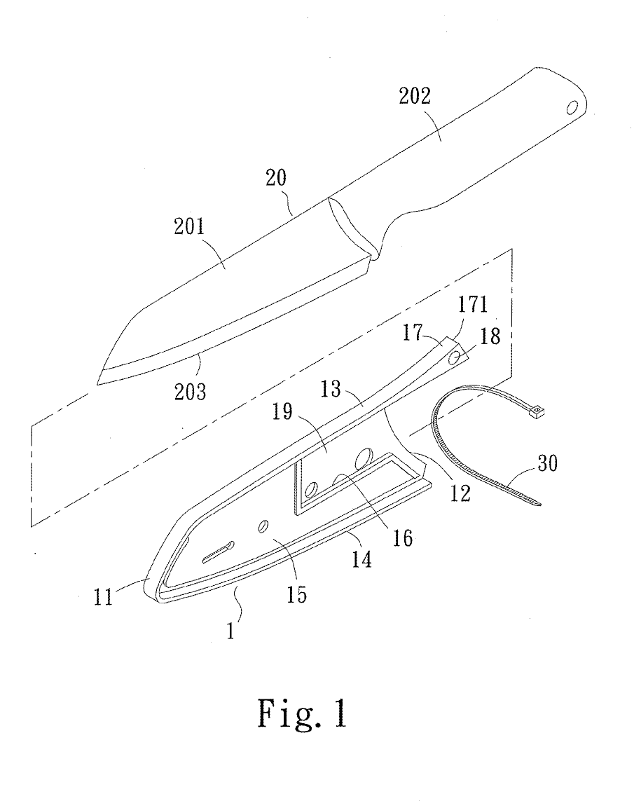

Please refer to FIGS. 1, 2 and 3, in which a knife case 1 according to a preferred embodiment of the present invention for receiving a blade 201 of a knife 20 therein is shown. The knife case 1 is integrally molded using a transparent plastic material or other composite materials to have a shape matching the blade 201 of the knife 20, and includes a front end 11, a rear end 12, an upper edge 13, a lower edge 14, and two lateral sides 15. A rearward opened blade receiving space 16 is defined on the knife case 1 to extend from the rear end 12 toward the front end 11. More specifically, the blade receiving space 16 is a narrow slot 161 extended from the rear end 12 toward the front end 11. A thumb push 17 is provided on the upper edge 14 to rearward project from the rear end 12. The thumb push 17 is a wedge-shaped block with a rear end of which serving as a thumb-push surface 171. A through hole 18 is provided on the thumb push 17 for a fastening strap 30 to extend therethrough. The through hole 18 is a round hole transversely extended through the wedge-shaped block. The knife case 1 of the present invention with the above-described structure can be used to receive the blade 201 of a knife 20, such as a fruit knife, a cook's knife or other type of cutter, in the blade receiving space 16.

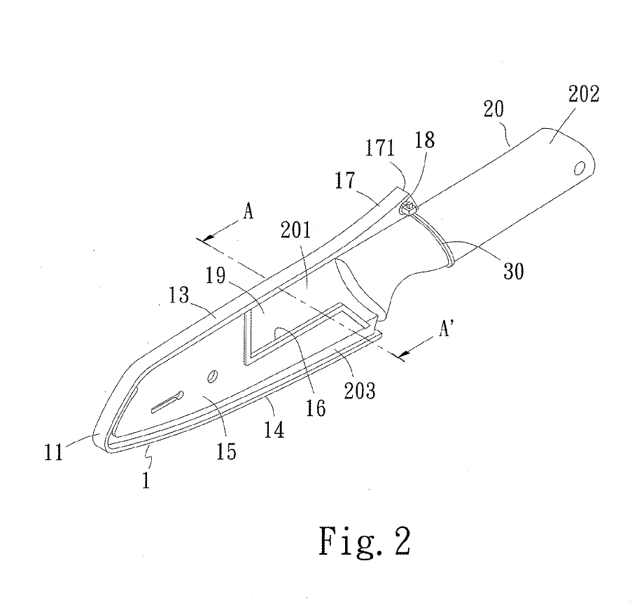

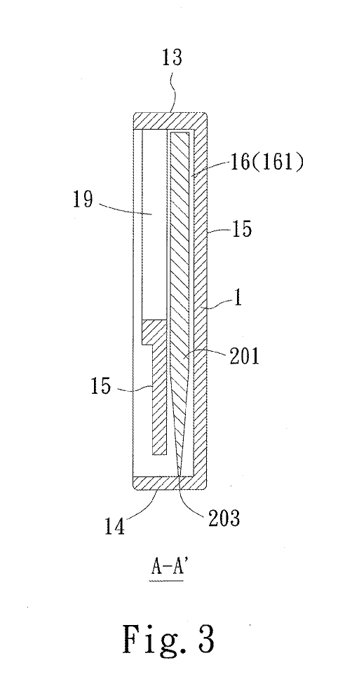

As can be seen from FIGS. 2 and 3, when the knife 20 is inserted into the knife case 1 of the present invention, the blade 201 of the knife 20 is received in the blade receiving space 16, i.e. the narrow slot 161, with a handle 202 of the knife 20 exposed from the rear end 12 of the knife case 1. In this manner, an edge 203 of the blade 201 of the knife 20 is well protected against damage while a user is protected against unintentional touch of the edge 203. Therefore, the knife case 1 according to the present invention enables safe storing of the knife 20 in the knife case 1. When a user wants to extract the knife 20 from the knife case 1, he or she needs only to grip at the handle 202 with one single hand, and then pushes against the thumb-push surface 171 of the thumb push 17 with the thumb of the same hand. At this point, the knife case 1 can be easily and effortlessly pushed forward to release from the blade 201, and the user can conveniently and safely remove the knife case 1 from the knife 20 with another hand. Particularly, as can be seen from FIG. 2, when the blade 201 of the knife 20 is received in the blade receiving space 16, i.e. the narrow slot 161, of the knife case 1 for storage, a conventional fastening strap 30 can be extended through the through hole 18 for securely tying to the handle 202, so as to prevent a consumer from arbitrarily extracting the knife 20 from the knife case 1 when the knife 20 and the knife case 1 thereof are displayed for sale. Meanwhile, the knife 20 along with the knife case 1 thereof can be safely displayed without the need of being packaged with additional boxes or other packing materials to thereby reduce packaging cost and achieve the purpose of environmental protection.

Further, as can be seen from FIG. 1, one of the two lateral sides 15 of the knife case 1 can be provided with a window 19, via which a trademark provided on a side face of the blade 201 can be shown.

With the above arrangements, the knife case according to the present invention is novel, improved and industrially practical for use. The present invention is novel and improved because the knife case 1 is provided at the rear end 12 thereof with the blade receiving space 16, the thumb push 17, and the through hole 18, so that the knife 20 can be safely stored in the knife case 1 for display with reduced packaging cost and be conveniently and safely released from the knife case 1 for use. Therefore, products derived from the present invention will no doubt satisfy the current market demands.

The present invention has been described with a preferred embodiment thereof and it is understood the embodiment is only for the purpose of illustration instead of limiting the scope of the present invention, and that many changes and modifications in the described embodiment can be carried out without departing from the scope and the spirit of the invention that is intended to be limited only by the appended claims.

What is claimed is:

1. A knife case for receiving a blade of a knife therein, comprising an integrally molded case having a shape matching the blade of the knife and including a front end, a rear end, an upper edge, a lower edge, and two lateral sides; a rearward opened blade receiving space being defined on the knife case to extend from the rear end toward the front end; a thumb push being provided on the upper edge to rearward project from the rear end; and a through hole being provided on the thumb push for a fastening strap to extend therethrough.

2. The knife case as claimed in claim 1, wherein the thumb push is a wedge-shaped block with a rear end of which serving as a thumb-push surface.

3. The knife case as claimed in claim 2, wherein the through hole is a round hole transversely extended through the wedge-shaped block.

4. The knife case as claimed in claim 1, wherein the knife case is provided on one of the two lateral sides with a window, via which a trademark provided on one side face of the blade of the knife is shown.

5. The knife case as claimed in claim 1, wherein the knife case is molded with a transparent plastic material.
